(19) United States
(12) Patent Application Publication
(10) Pub. No.: US 2025/0102871 A1
(43) Pub. Date: Mar. 27, 2025

(54) PHASE MODULATION DEVICE, AND METHOD OF MANUFACTURING PHASE MODULATION DEVICE

(71) Applicant: SONY GROUP CORPORATION, TOKYO (JP)

(72) Inventors: SHUNICHI SUWA, TOKYO (JP); NOBUO IWASAKI, TOKYO (JP)

(21) Appl. No.: 18/832,571

(22) PCT Filed: Dec. 9, 2022
(86) PCT No.: PCT/JP2022/045491

§ 371 Date: Jul. 24, 2024

(30) Foreign Application Priority Data
Feb. 1, 2022 (JP) 2022-014471

(51) Int. Cl. G02F 1/137; G02F 1/1337; G02F 1/1343

(52) U.S. Cl. CPC G02F 1/13712; G02F 1/13439; G02F 1/133784; G02F 1/133788; G02F 2203/50

(57) ABSTRACT

A phase modulation device according to the present disclosure includes: a first substrate having an electrode; a second substrate opposed to the first substrate; and a liquid crystal layer containing liquid crystal molecules, the liquid crystal layer being disposed between the first substrate and the second substrate. An angle between a direction of electric field applied to the liquid crystal layer and a direction of alignment of the liquid crystal molecules when the electric field is not applied is 2° or more and 20° or less.

### TECHNICAL FIELD

The present disclosure relates to a phase modulation device and a method of manufacturing a phase modulation device.

### BACKGROUND ART

A liquid crystal display device having liquid crystal molecules tilted in the regulated direction has been proposed (PTL 1). Phase modulation devices using liquid crystal have also been proposed.

### CITATION LIST

### Patent Literature

PTL 1: Japanese Unexamined Patent Application Publication No. 2003-177408

### SUMMARY OF THE INVENTION

Phase modulation devices are required to enhance their performance.

It is desirable to a provide phase modulation device with good performance.

A phase modulation device according to one embodiment of the present disclosure includes: a first substrate having an electrode; a second substrate opposed to the first substrate; and a liquid crystal layer including liquid crystal molecules, the liquid crystal layer being disposed between the first substrate and the second substrate. An angle between the direction of electric field generated in the liquid crystal layer when a voltage is applied to the electrode and the direction of alignment of liquid crystal molecules when the voltage is not applied is 2° or more and 20° or less.

A method of manufacturing a phase modulation device according to one embodiment of the present disclosure includes: forming a liquid crystal layer including liquid crystal molecules between a first substrate having an electrode and a second substrate; and aligning the liquid crystal molecules to cause an angle between a direction of electric field generated in the liquid crystal layer when a voltage is applied to the electrode and a direction of alignment of the liquid crystal molecules when the voltage is not applied to be 2° or more and 20° or less.

### BRIEF DESCRIPTION OF DRAWING

FIG. 1 illustrates an example configuration of a phase modulation device according to a first embodiment of the present disclosure.

FIG. 2 illustrates an example of the relationship between the pretilt angle, response time, and contrast of the phase modulation device according to the first embodiment of the present disclosure.

FIG. 3 is a flowchart illustrating an example of the method of manufacturing the phase modulation device according to the first embodiment of the present disclosure.

FIG. 4A illustrates an example of the method of manufacturing the phase modulation device according to the first embodiment of the present disclosure.

FIG. 4B illustrates an example of the method of manufacturing the phase modulation device according to the first embodiment of the present disclosure.

FIG. 4C illustrates an example of the method of manufacturing the phase modulation device according to the first embodiment of the present disclosure.

FIG. 5 illustrates an example configuration of a phase modulation device according to Modification Example 1 of the present disclosure.

FIG. 6 illustrates an example configuration of a phase modulation device according to Modification Example 2 of the present disclosure.

FIG. 7 illustrates an example configuration of a phase modulation device according to a second embodiment of the present disclosure.

FIG. 8 is a flowchart illustrating an example of the method of manufacturing the phase modulation device according to the second embodiment of the present disclosure.

FIG. 9A illustrates an example of the method of manufacturing the phase modulation device according to the second embodiment of the present disclosure.

FIG. 9B illustrates an example of the method of manufacturing the phase modulation device according to the second embodiment of the present disclosure.

FIG. 9C illustrates an example of the method of manufacturing the phase modulation device according to the second embodiment of the present disclosure.

FIG. 10 illustrates an example configuration of a phase modulation device according to a third embodiment of the present disclosure.

FIG. 11 is a flowchart illustrating an example of the method of manufacturing the phase modulation device according to the third embodiment of the present disclosure.

FIG. 12A illustrates an example of the method of manufacturing the phase modulation device according to the third embodiment of the present disclosure.

FIG. 12B illustrates an example of the method of manufacturing the phase modulation device according to the third embodiment of the present disclosure.

FIG. 12C illustrates an example of the method of manufacturing the phase modulation device according to the third embodiment of the present disclosure.

FIG. 12D illustrates an example of the method of manufacturing the phase modulation device according to the third embodiment of the present disclosure.

FIG. 12E illustrates an example of the method of manufacturing the phase modulation device according to the third embodiment of the present disclosure.

FIG. 12F illustrates an example of the method of manufacturing the phase modulation device according to the third embodiment of the present disclosure.

FIG. 13 illustrates an example configuration of a phase modulation device according to Modification Example 3 of the present disclosure.

FIG. 14 illustrates an example configuration of a phase modulation device according to a fourth embodiment of the present disclosure.

FIG. 15 is a flowchart illustrating an example of the method of manufacturing the phase modulation device according to the fourth embodiment of the present disclosure.

FIG. 16A illustrates an example of the method of manufacturing the phase modulation device according to the fourth embodiment of the present disclosure.

FIG. 16B illustrates an example of the method of manufacturing the phase modulation device according to the fourth embodiment of the present disclosure.

FIG. 16C illustrates an example of the method of manufacturing the phase modulation device according to the fourth embodiment of the present disclosure.

### MODES FOR CARRYING OUT THE INVENTION

The following describes embodiments of the present disclosure in details with reference to the drawings. Note that the explanation will be given in the following order.
1. First Embodiment
2. Second Embodiment
3. Third Embodiment
4. Fourth Embodiment

### 1. First Embodiment

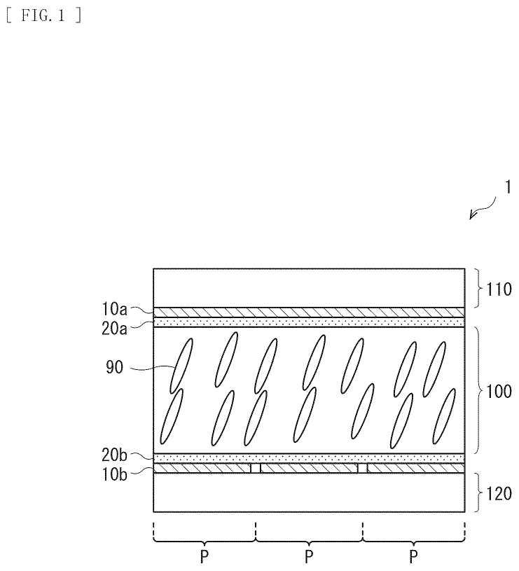

FIG. 1 illustrates an example configuration of a phase modulation device according to a first embodiment of the present disclosure. The phase modulation device 1 is a device that modulates the phase of incident light. The phase modulation device 1 is a liquid-crystal phase modulation device, and controls the phase of light using liquid crystal. The phase modulation device 1 is able to control the wavefront of light and output any pattern of light. The phase modulation device 1 is applicable to an optical device, a laser processor, and other devices. Note that the phase modulation device 1 may be a transmissive liquid crystal device or a reflective liquid crystal device.

The phase modulation device 1 has a plurality of pixels P, and controls the phase of light for each pixel P. In the phase modulation device 1, a plurality of pixels P is arranged two-dimensionally. As illustrated in FIG. 1, the phase modulation device 1 includes a first substrate 110, a second substrate 120, and a liquid crystal layer 100. The first substrate 110 and second substrate 120 are fixed with a sealing member (not illustrated) with the liquid crystal layer 100 in between. These first substrate 110 and second substrate 120 as a pair are disposed apart from each other in their stacking direction. The phase modulation device 1 has a predetermined cell gap (thickness of the liquid crystal layer). The cell gap of the phase modulation device 1 is to obtain a desired amount of phase modulation. Note that polarizers are disposed above the first substrate 110 and below the second substrate 120 as necessary.

The first substrate 110 is a transparent substrate that transmits light, and includes a glass substrate, for example. The first substrate 110 comes with a first electrode 10a. FIG. 1 illustrates an example, in which the first substrate 110 has the first electrode 10a on the face that is opposed to the second substrate 120. The first electrode 10a is a transparent electrode, and includes indium tin oxide (ITO), for example. The first electrode 10a is an electrode common to the plurality of pixels P, and may also be called a common electrode.

The second substrate 120 is opposed to the first substrate 110. The second substrate 120 includes a glass substrate or a semiconductor substrate (e.g., silicon substrate), for example. The second substrate 120 comes with a second electrode 10b. FIG. 1 illustrates an example, in which the second substrate 120 has the second electrode 10b on the face that is opposed to the first substrate 110. The second electrode 10b is opposed to the first electrode 10a with part of the liquid crystal layer 100 in between.

The second electrode 10b includes aluminum (Al), for example. Note that the second electrode 10b may include a transparent material such as ITO. The second electrode 10b is provided for each pixel P, and may also be called a pixel electrode. The second substrate 120 further includes elements such as transistors and wiring formed thereon. The second substrate 120 comes with drive circuits, each of which drives a corresponding pixel P.

The liquid crystal layer 100 contains a plurality of liquid crystal molecules 90 and is disposed between the first substrate 110 and the second substrate 120. The liquid crystal layer 100 is sealed between the first and second substrates 110 and 120 by a sealing member. When voltage is applied to between the first electrode 10a and the second electrode 10b, the liquid crystal molecules 90 of the liquid crystal layer 100 having dielectric anisotropy respond, thus making it possible to control the alignment of the liquid crystal molecules 90. FIG. 1 illustrates an example, in which the electric field applied to the liquid crystal layer 100 by the first electrode 10a and the second electrode 10b is in the opposing direction of the first substrate 110 and the second substrate 120. In one example, the liquid crystal layer 100 includes a negative-type liquid crystal material. The liquid crystal molecules 90 of the liquid crystal layer 100 have negative dielectric constant anisotropy. Note that the liquid crystal layer 100 may include a positive-type liquid crystal material, and the liquid crystal molecules 90 may have positive dielectric constant anisotropy.

The phase modulation device 1 also has a polymer layer 20 (in FIG. 1, a first polymer layer 20a and a second polymer layer 20b). The polymer layer 20 includes a polymer that is polymerized. The polymer layer 20 includes a monomer that is added to the composition that makes up the liquid crystal layer 100. For instance, the monomer used is a monomer whose polymerization proceeds by irradiation with light (energy rays). In the example illustrated in FIG. 1, the first polymer layer 20a is located between the liquid crystal layer 100 and the first electrode 10a, and is disposed on the first electrode 10a. The second polymer layer 20b is located between the liquid crystal layer 100 and the second electrode 10b, and is disposed on the second electrode 10b.

In one example, the polymer layer 20 is formed by applying light (e.g., ultraviolet light and visible light) to the liquid crystal layer 100 while applying voltage to the liquid crystal layer 100 via the first electrode 10a and the second electrode 10b. For example, the liquid crystal layer 100 containing a polymerizable monomer is sealed between the first substrate 110 and the second substrate 120. Then, while voltage is applied to the liquid crystal layer 100 to tilt the liquid crystal molecules 90, the liquid crystal layer 100 is irradiated with light. The liquid crystal layer 100 is irradiated with light while the alignment of the liquid crystal molecules 90 is controlled by the electric field by the first 10a and second 10b electrodes. Thereby, the polymerizable monomer is polymerized and cured to form the first polymer layer 20a and the second polymer layer 20b. Note that, in another example, the liquid crystal layer 100 may be irradiated with light while the alignment of the liquid crystal molecules 90 is controlled by magnetic field. Thereby, the polymer layer 20 may be formed.

The monomer is polymerized while tilting the liquid crystal molecules 90, whereby the polymers subjected to phase separation due to the polymerization adhere to the first substrate 110 and the second substrate 120. This forms the first polymer layer 20a and the second polymer layer 20b that tend to keep the liquid crystal molecules 90 aligned. The first polymer layer 20a is formed closer to the first substrate 110 in the liquid crystal layer 100, and the second polymer layer 20b is formed closer to the second substrate 120 in the liquid crystal layer 100. Thus, after the supply of voltage is stopped, the liquid crystal molecules 90 of the liquid crystal layer 100 are held to be tilted by the first polymer layer 20a and the second polymer layer 20b, as illustrated in FIG. 1. That is, a predetermined pretilt angle (tilt angle) is given to the liquid crystal molecules 90 of the liquid crystal layer 100.

The pretilt angle of the liquid crystal molecules 90 is adjustable by the magnitude of the voltage applied to the liquid crystal layer 100 during the monomer polymerization described above. The first polymer layer 20a and the second polymer layer 20b may each also be called an alignment film (alignment layer) that induces alignment of the liquid crystal molecules 90 contained in the liquid crystal layer 100. Note that a monomer whose polymerization proceeds by applying heat may be used for the polymerizable monomer.

The phase modulation device 1 changes the electric field in the liquid crystal layer 100 with the voltage input between the first electrode 10a and the second electrode 10b, and changes the orientation of the liquid crystal molecules 90. In this case, the pre-tilted liquid crystal molecules 90 tilt in accordance with the magnitude of the electric field caused by the applied voltage (potential difference). The voltage supplied to the second electrode 10b of each pixel P is controlled, whereby making it possible to adjust the orientation of the liquid crystal molecules 90 and change the refractive index for each pixel P. The orientation of the liquid crystal molecules 90 in each pixel P is set in accordance with the voltage at the second electrode 10b in each pixel P. The light incident on each pixel P of the phase modulation device 1 is phase modulated in accordance with the amount of tilting of the liquid crystal molecules 90 in each pixel P, and the modulated light is emitted from the pixel P. The phase modulation device 1 causes a different phase delay from the incident light for each pixel P, thus making it possible to propagate the light with a desired wavefront.

In addition, as described above, the phase modulation device 1 is configured to tilt the liquid crystal molecules 90 in the liquid crystal layer 100 by a pretilt angle relative to the surface of the first substrate 110 (or second substrate 120) when no voltage is applied between the first electrode 10a and the second electrode 10b. This makes it possible to determine in advance the tilting direction of the liquid crystal molecules when voltage is applied, thereby improving the response speed of the liquid crystal molecules.

The phase modulation device 1 according to the present embodiment has the angle between the direction of electric field generated in the liquid crystal layer 100 when voltage is applied and the direction of alignment of liquid crystal molecules when no voltage is applied that is 2° or more and 20° or less, preferably 5° or more and 15° or less. For instance, in the case of the vertical alignment (VA) method, the alignment of the liquid crystal molecules 90 is adjusted so that the pre-tilt angle of the liquid crystal molecules 90 is 88° to 70°. This makes it possible to improve the response speed of the phase modulation device 1. The following further describes the phase modulation device 1 according to the present embodiment.

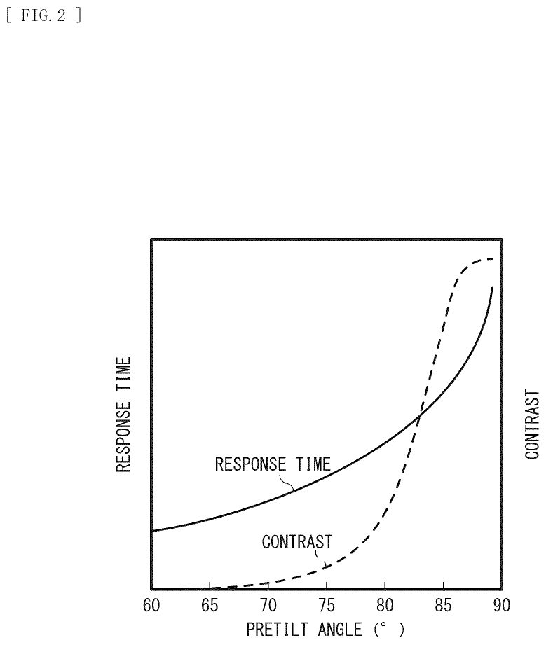

FIG. 2 illustrates an example of the relationship between the pretilt angle, response time, and contrast of the phase modulation device according to the first embodiment. In FIG. 2, the horizontal axis represents the pretilt angle of the liquid crystal molecules 90 in the liquid crystal layer 100. The vertical axis on the left represents the response time, and the vertical axis on the right represents the contrast. FIG. 2 illustrates an example for the vertical alignment method. The liquid crystal molecules 90 in the liquid crystal layer 100 have negative dielectric anisotropy, that is, the dielectric constant in the long axis direction of the liquid crystal molecules is smaller than the dielectric constant in the short axis direction of the liquid crystal molecules. When the pretilt angle is 90°, the long axis of the liquid crystal molecules 90 is aligned perpendicular to the surface of the first substrate 110 (or the second substrate 120). The pretilt angle may be also called the tilting angle of the long axis of the liquid crystal molecules relative to the opposing direction of the first substrate 110 and the second substrate 120.

In FIG. 2, the solid line indicates the response time of the liquid crystal layer 100 when voltage is applied, that is, the response speed. The dotted line indicates the contrast of an image formed by the light modulated by the phase modulation device 1. The response time of the liquid crystal layer 100 indicated by the solid line corresponds to the time from when voltage V is applied between the first electrode 10a and the second electrode 10b until the liquid crystal molecules 90 become tilted according to the voltage V. The response time of the liquid crystal layer 100 may also be called the time required to switch the alignment direction of the liquid crystal molecules 90.

As illustrated in FIG. 2, when the pretilt angle approaches 60°, that is, when the long axes of the liquid crystal molecules are preliminarily tilted significantly toward the horizontal direction, the response time becomes shorter when voltage is applied. Thus, the liquid crystal layer 100 in this embodiment is formed so that the pretilt angle is 88° to 70°. Preferably, the liquid crystal layer 100 is formed so that the pretilt angle is 85° to 75°. The present embodiment therefore is able to shorten the response time of the liquid crystal molecules to the applied voltage and enhance the response speed. The phase modulation device 1 is capable of high-speed response.

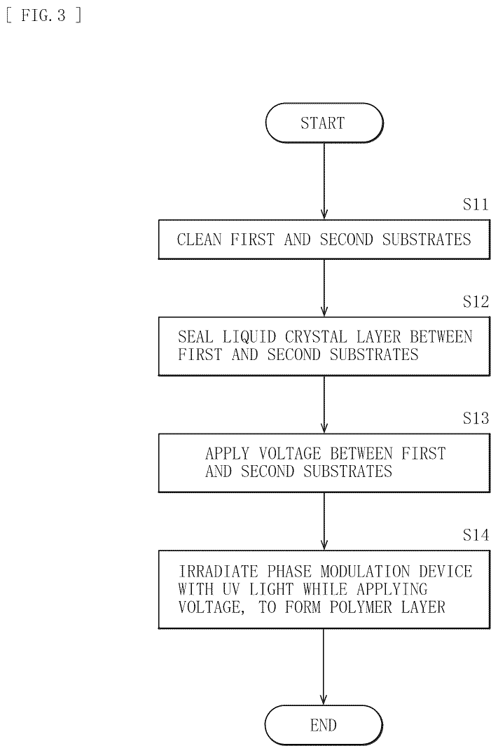

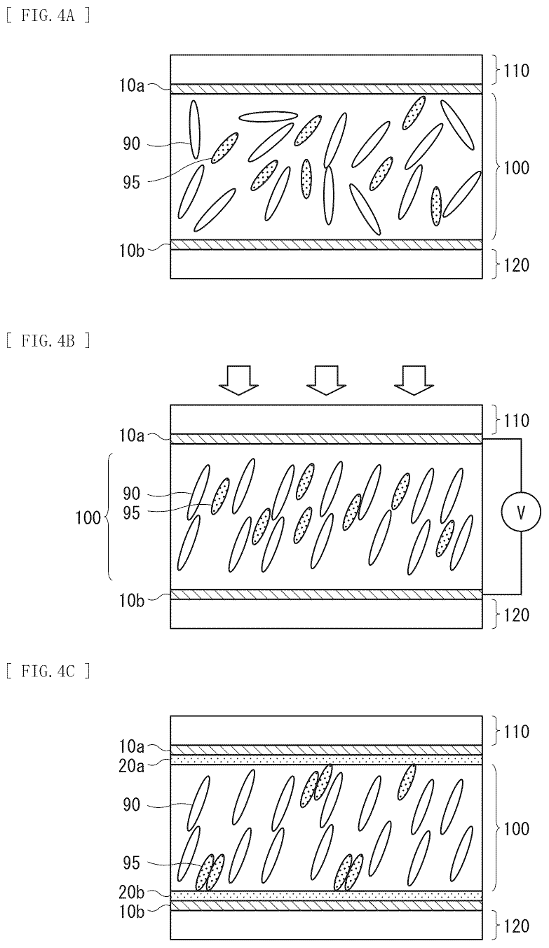

FIG. 3 is a flowchart illustrating an example of the method of manufacturing the phase modulation device according to the first embodiment. Referring to this flowchart in FIG. 3 and FIGS. 4A through 4C, the following describes an example of the method of manufacturing the phase modulation device 1. In step S11, after forming the first electrode 10a on the first substrate 110, which is a glass substrate, by sputtering and photolithography, the first substrate 110 is cleaned. Further, after forming the second electrode 10b, a transistor, and others on the second substrate 120, which is a silicon substrate, by sputtering, CVD, EB evaporation, photolithography, and other methods, the second substrate 120 is cleaned.

In step S12, the first substrate 110 and the second substrate 120 are made to face each other, and the first substrate 110 and the second substrate 120 are bonded together using a sealing member mixed with glass beads. In this step, the sealing member seals the liquid crystal layer 100 containing liquid crystal molecules 90 and polymerizable monomer 95 (see FIG. 4) between the first substrate 110 and the second substrate 120. For instance, the liquid crystal layer 100 includes a liquid crystal composition that is prepared by mixing 4-(6-Acryloxy-hex-1-yl-oxy)phenyl 4-(hexyloxy)benzoat (manufactured by Wako Pure Chemical Corporation) and 1,4-Bis(4-(3-acryloyloxypropoxy)benzoyloxy))-2-methylbenzene (manufactured by Tokyo Kasei Kogyo) at a ratio of 1:4, and mixing 5.0 wt % of the resultant mixture with a negative-type liquid crystal material. The liquid crystal composition is injected between the first and second substrates 110 and 120 to form the liquid crystal layer 100, and the phase modulation device 1 illustrated in FIG. 4A is manufactured.

In step S13, as schematically illustrated in FIG. 4B, an AC electric field (e.g., a square wave AC electric field with an RMS voltage of 40 V and a frequency of 60 Hz) is applied to the phase modulation device 1 via the first electrode 10a and second electrode 10b. Note that, in some cases, a DC electric field may be applied to the phase modulation device 1. In step S14, while the AC electric field (or DC electric field) is applied to the phase modulation device 1, the phase modulation device 1 is irradiated with ultraviolet rays as indicated by the arrows in FIG. 4B. In this case, the phase modulation device 1 is irradiated with ultraviolet light with an irradiation dose (exposure dose) of 500 mJ/cm² at a wavelength of 365 nm, for example. As illustrated in FIG. 4C, this forms the first polymer layer 20a and the second polymer layer 20b in the phase modulation device 1, and gives the liquid crystal molecules of the liquid crystal layer 100 a pretilt angle (e.g., the pretilt angle is about 8.5°). The manufacturing method as described above produces the phase modulation device 1 illustrated in FIG. 1.

### Workings and Effects

The phase modulation device 1 according to the present embodiment includes: a first substrate having an electrode; a second substrate opposed to the first substrate; and a liquid crystal layer (liquid crystal layer 100) containing liquid crystal molecules, the liquid crystal layer being disposed between the first substrate and the second substrate. The phase modulation device has the angle between the direction of electric field generated in the liquid crystal layer when voltage is applied to the electrode and the direction of alignment of liquid crystal molecules when no voltage is applied, the angle being 2° or more and 20° or less, preferably 5° or more and 15° or less.

The phase modulation device 1 has the magnitude of angle between the direction of electric field generated in the liquid crystal layer 100 when voltage is applied and the direction of alignment of liquid crystal molecules 90 when no voltage is applied, the angle being 2° or more and 20° or less, preferably 5° or more and 15° or less. This makes it possible to improve the response speed of the phase modulation device 1. This makes it possible to realize the phase modulation device 1 with high response performance.

Next, the following describes modification examples of the present disclosure. In the following description, like reference numerals designate like parts of the embodiment as stated above, and their description is omitted as appropriate.

### 1-1. Modification Example 1

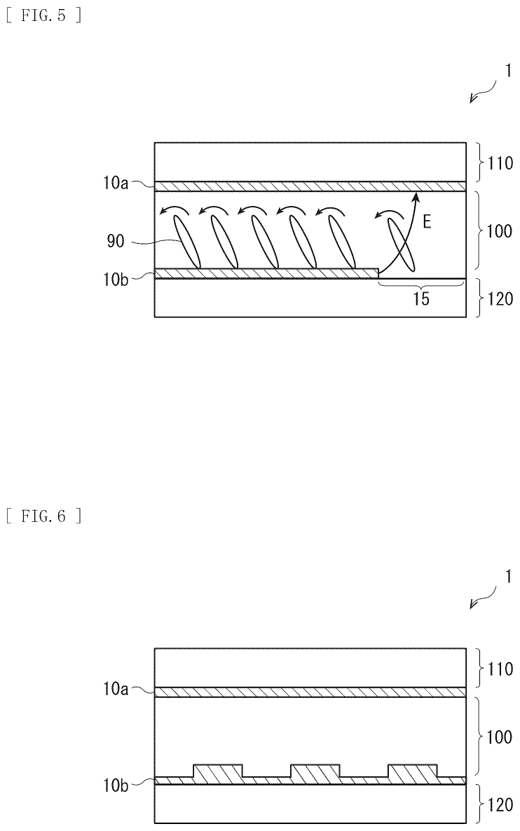

FIG. 5 illustrates an example configuration of a phase modulation device according to Modification Example 1. In the phase modulation device 1 according to this modification example, the second electrode 10b has a shape including a slit. FIG. 5 illustrates an example, in which a slit 15 is formed in the second substrate 120 by notching a portion of the second electrode 10b. Although not illustrated, the second polymer layer 20b described above is provided to cover the second electrode 10b and the slit 15, and the first polymer layer 20a described above is provided to cover the first electrode 10a.

When voltage is applied to the first electrode 10a and the second electrode 10b, an oblique electric field is generated at the end (edge) of the second electrode 10b as schematically illustrated in FIG. 5. This makes it possible to generate an electric field in a direction oblique to the long axis or short axis of the liquid crystal molecules 90 of the liquid crystal layer 100, and to control the direction in which the liquid crystal molecules 90 are aligned, and thus determine the pretilt direction of the liquid crystal molecules. For example, the first polymer layer 20a and the second polymer layer 20b may be formed by polymerizing the monomer while applying an electric field. This makes it possible to obtain a desired pretilt of the liquid crystal molecules. The pretilt angle is given to the liquid crystal molecules 90 beforehand. This makes it possible to improve the response speed of the phase modulation device 1. Note that the first electrode 10a may have a shape including a slit.

### 1-2. Modification Example 2

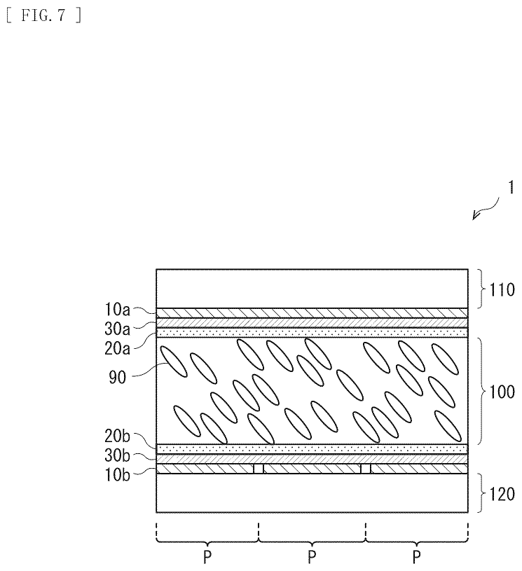

FIG. 6 illustrates an example configuration of a phase modulation device according to Modification Example 2. In the phase modulation device 1 according to this modification example, the second electrode 10b has a shape including a unevenness. As illustrated in FIG. 6, the second electrode 10b includes a plurality of recesses and protrusions, and has an uneven structure. This uneven shape may be formed using lithography and etching (wet etching or dry etching). Although not illustrated, the second polymer layer 20b is provided to cover the recesses and protrusions of the second electrode 10b, and the first polymer layer 20a is provided to cover the first electrode 10a.

When voltage is applied to the first electrode 10a and the second electrode 10b, an oblique electric field is generated due to the recesses and protrusions of the second electrode 10b. This modification example also makes it possible to generate an electric field in a direction oblique to the long axis or short axis of the liquid crystal molecules 90, and to control the direction in which the liquid crystal molecules 90 are aligned, and thus determine the pretilt direction of the liquid crystal molecules. The pretilt angle is given to the liquid crystal molecules 90 beforehand. This makes it possible to improve the response speed of the phase modulation device 1. Note that the first electrode 10a may have the even shape.

### 2. Second Embodiment

Next, the following describes a second embodiment of the present disclosure. In the following description, like reference numerals designate like parts of the embodiment as stated above, and their description is omitted as appropriate.

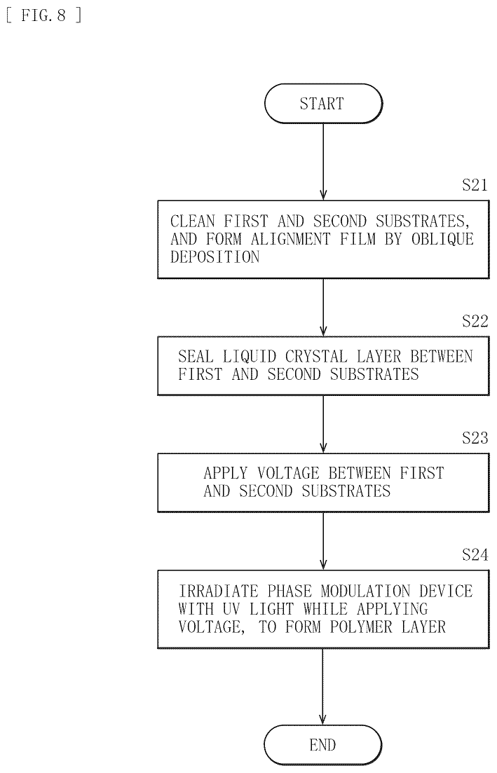

FIG. 7 illustrates an example configuration of a phase modulation device according to a second embodiment of the present disclosure. The phase modulation device 1 has an alignment film 30 (in FIG. 7, a first alignment film 30a and a second alignment film 30b). The alignment film 30 is able to align the liquid crystal molecules 90 of the liquid crystal layer 100 in a specific direction. The alignment film 30 is a film (layer) that is able to control the alignment of the liquid crystal molecules 90.

In one example, the alignment film 30 includes a film formed by oblique deposition (obliquely deposited film). For instance, the obliquely deposited film is formed by depositing an inorganic material obliquely to the surface of a substrate, and has columnar bodies that are inclined relative to the surface of the substrate. The obliquely deposited film is a SiO₂ film (silicon oxide film), for example. Note that the surface of the SiO₂ film may be treated with a silane coupling agent (silane coupling treatment). The obliquely deposited film may be a film including a silicon nitride film (SiN), a silicon oxynitride film (SiON), or other films.

In the example illustrated in FIG. 7, the first alignment film 30a is located between the liquid crystal layer 100 and the first electrode 10a, and is provided to cover the first electrode 10a. The second alignment film 30b is located between the liquid crystal layer 100 and the second electrode 10b, and is provided to cover the second electrode 10b. The first alignment film 30a and the second alignment film 30b are disposed with the liquid crystal layer 100 in between. The liquid crystal molecules 90 in the liquid crystal layer 100 are tilted in a specific direction by the first alignment film 30a and the second alignment film 30b. That is, the liquid crystal molecules 90 of the liquid crystal layer 100 are given a predetermined pretilt angle.

The phase modulation device 1 according to the present embodiment includes the alignment film 30, and the alignment film 30 is able to give a pretilt angle to the liquid crystal molecules 90 in the liquid crystal layer 100. This makes it possible to determine in advance the tilting direction of the liquid crystal molecules 90 when voltage is applied, and to improve the response speed of the liquid crystal molecules 90. As in the example of FIG. 7, the phase modulation device 1 may also have a polymer layer 20 (a first polymer layer 20a and a second polymer layer 20b). In this case, after the liquid crystal molecules 90 are aligned by the alignment film 30, the polymer layer 20 allows the liquid crystal molecules 90 to realign. The polymer layer 20 is able to give a larger pretilt angle to the direction defined by the alignment film 30. This allows the liquid crystal molecules 90 to be given a larger pretilt angle than when a pretilt angle is given to the liquid crystal molecules 90 only by the alignment film 30, which makes it possible to realize a desired pretilt angle. This makes it possible to prevent insufficient pre-tilting and lack of responsiveness. Compared to the case where only the alignment film 30 is provided, a faster response of the phase modulation device 1 is expectable.

In the phase modulation device 1, the alignment direction of liquid crystal modules is controlled so that the angle between the direction of electric field generated in the liquid crystal layer 100 when voltage is applied and the direction of alignment of liquid crystal molecules when no voltage is applied is 2° or more and 20° or less, preferably 5° or more and 15° or less. For instance, in the case of the VA method, the alignment of the liquid crystal molecules 90 is adjusted by the alignment film 30 and the polymer layer 20 so that the pre-tilt angle of the liquid crystal molecules 90 is 88° to 70°, preferably 85° to 75°. This makes it possible to improve the response speed of the phase modulation device 1.

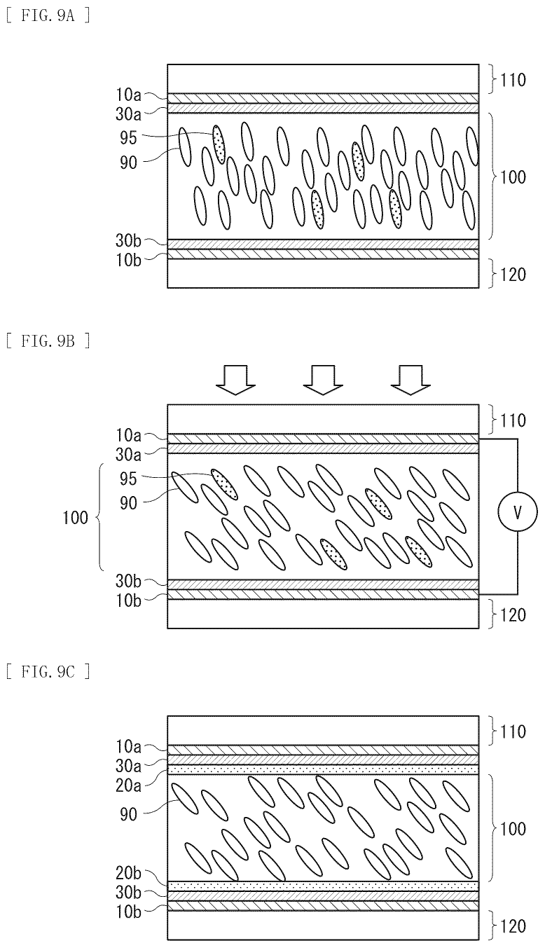

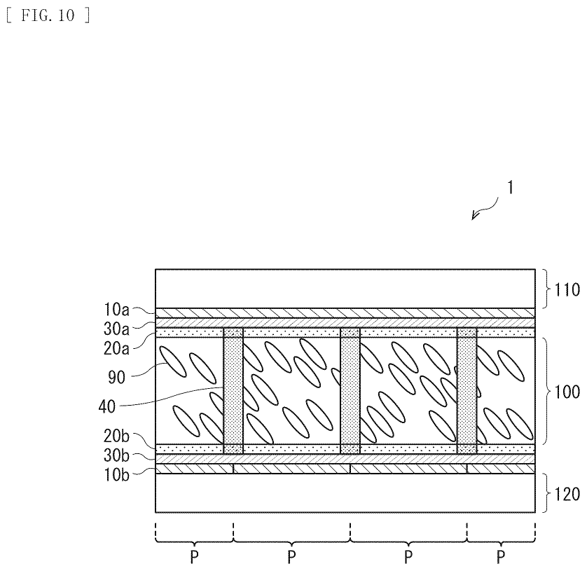

FIG. 8 is a flowchart illustrating an example of the method of manufacturing the phase modulation device according to the second embodiment. Referring to this flowchart in FIG. 8 and FIGS. 9A through 9C, the following describes an example of the method of manufacturing the phase modulation device 1. In step S21, after forming the first electrode 10a on the first substrate 110, which is a glass substrate, by sputtering and photolithography, the first substrate 110 is cleaned. Further, F after forming the second electrode 10b, a transistor, and others on the second substrate 120, which is a silicon substrate, by sputtering, CVD, EB evaporation, photolithography, and other methods, the second substrate 120 is cleaned.

Oblique deposition is performed to the surface of the first substrate 110 with the deposition angle within the range of 45° to 60°, thus forming a SiO₂ film that is the first alignment film 30a. Oblique deposition is also performed to the surface of the second substrate 120 with the deposition angle within the range of 45° to 60°, thus forming a SiO₂ film that is the second alignment film 30b. The first alignment film 30a and the second alignment film 30b each have a thickness of 50 nm, for example.

In step S22, the first substrate 110 and the second substrate 120 are made to face each other, and the first substrate 110 and the second substrate 120 are bonded together using a sealing member mixed with glass beads. In this step, the sealing member seals the liquid crystal layer 100 containing liquid crystal molecules 90 and polymerizable monomer 95 between the first substrate 110 and the second substrate 120. For instance, the liquid crystal layer 100 includes a liquid crystal component that is prepared by mixing 3.0 wt % of 1,4-Bis(4-(3-acryloyloxypropoxy)benzoyloxy)-2-methylbenzene (manufactured by Tokyo Kasei Kogyo) with negative liquid crystal material, for example. This produces the phase modulation device 1 illustrated in FIG. 9A.

In step S23, as schematically illustrated in FIG. 9B, an AC electric field (e.g., a square wave AC electric field with an RMS voltage of 40 V and a frequency of 60 Hz) is applied to the phase modulation device 1 via the first electrode 10a and second electrode 10b. Note that, in some cases, a DC electric field may be applied to the phase modulation device 1. In step S24, while the AC electric field (or DC electric field) is applied to the phase modulation device 1, the phase modulation device 1 is irradiated with ultraviolet rays. In this case, the phase modulation device 1 is irradiated with ultraviolet light with an irradiation dose of 500 mJ/cm² at a wavelength of 365 nm, for example. This forms the first polymer layer 20a and the second polymer layer 20b in the phase modulation device 1, as illustrated in FIG. 9C. The manufacturing method as described above produces the phase modulation device 1 illustrated in FIG. 7.

Note that although the above describes an example configuration of the phase modulation device 1 including the alignment film 30, this is just an example. The configuration of the phase modulation device 1 is not limited to the example described above. The phase modulation device 1 may have a configuration including only one of the first alignment film 30a and the second alignment film 30b. The alignment film 30 may include an organic material.

The alignment film 30 may be a film made of an organic material such as polyimide. The alignment film 30 may be a film whose alignment direction is defined by a rubbing process. For instance, in the rubbing process, the organic film formed on the substrate is rubbed with a roller wrapped in cloth to form the alignment film 30. Further, a photo-alignment film may be used as the alignment film 30, and the alignment film 30 may be a film containing a group that is sensitive to light (photosensitive group). For instance, the alignment film 30 may be a photo-alignment film with a main chain (e.g., SiO or polyimide) and photosensitive groups as side chains.

### Workings and Effects

The phase modulation device 1 according to the present embodiment includes: a first substrate having an electrode; a second substrate opposed to the first substrate; a liquid crystal layer (liquid crystal layer 100) containing liquid crystal molecules, the liquid crystal layer being disposed between the first substrate and the second substrate; and an alignment film (alignment film 30) disposed on the electrode between the first substrate and the second substrate. The phase modulation device has the angle between the direction of electric field generated in the liquid crystal layer when voltage is applied to the electrode and the direction of alignment of liquid crystal molecules 90 when no voltage is applied, the angle being 2° or more and 20° or less, preferably 5° or more and 15° or less.

The phase modulation device 1 includes the alignment film 30 that aligns the liquid crystal molecules. The phase modulation device has the angle between the direction of electric field generated in the liquid crystal layer 100 when voltage is applied and the direction of alignment of liquid crystal molecules when no voltage is applied, the angle being 2° or more and 20° or less, preferably 5° or more and 15° or less. This makes it possible to improve the response speed of the phase modulation device 1. This makes it possible to realize the phase modulation device 1 with high response performance.

### 3. Third Embodiment

Next, the following describes a third embodiment of the present disclosure. In the following description, like reference numerals designate like parts of the embodiments as stated above, and their description is omitted as appropriate.

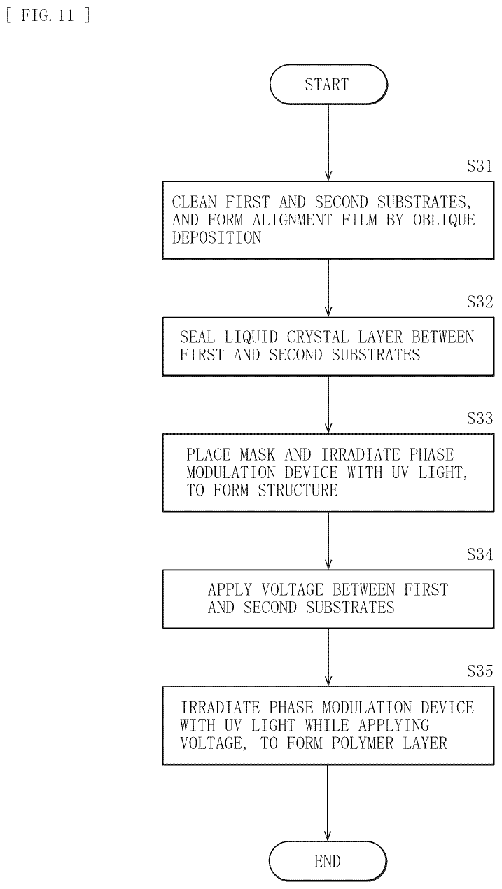

FIG. 10 illustrates an example configuration of a phase modulation device according to a third embodiment of the present disclosure. As illustrated in FIG. 10, the phase modulation device 1 includes a structure 40. For instance, the structure 40 includes a polymer that is polymerized, and is disposed between the first substrate 110 and the second substrate 120. A part of the structure 40 is disposed at the boundary between adjacent pixels P. In the example of FIG. 10, the structure 40 is formed to couple the first substrate 110 and the second substrate 120. The structure 40 may also be called a separation wall that separates pixels.

The phase modulation device 1 according to the present embodiment includes the structure 40, and the structure 40 is able to enhance the alignment-regulating force for the liquid crystal molecules in the pixels. Compared to the configuration where the first alignment film 30a and the second alignment film 30b only give an alignment-regulating force to the liquid crystal molecules 90, this configuration makes it possible to achieve a stronger alignment-regulating force. This shortens the response time of the liquid crystal molecules 90 when the application of voltage is stopped from the state where the voltage is applied, thereby making it possible to improve the response speed.

In the phase modulation device 1, the alignment direction of liquid crystal modules is controlled so that the angle between the direction of electric field generated in the liquid crystal layer 100 when voltage is applied and the direction of alignment of liquid crystal molecules when no voltage is applied is 2° or more and 20° or less, preferably 5° or more and 15° or less. This shortens the response time of the liquid crystal molecules when voltage is applied, thereby making it possible to improve the response speed.

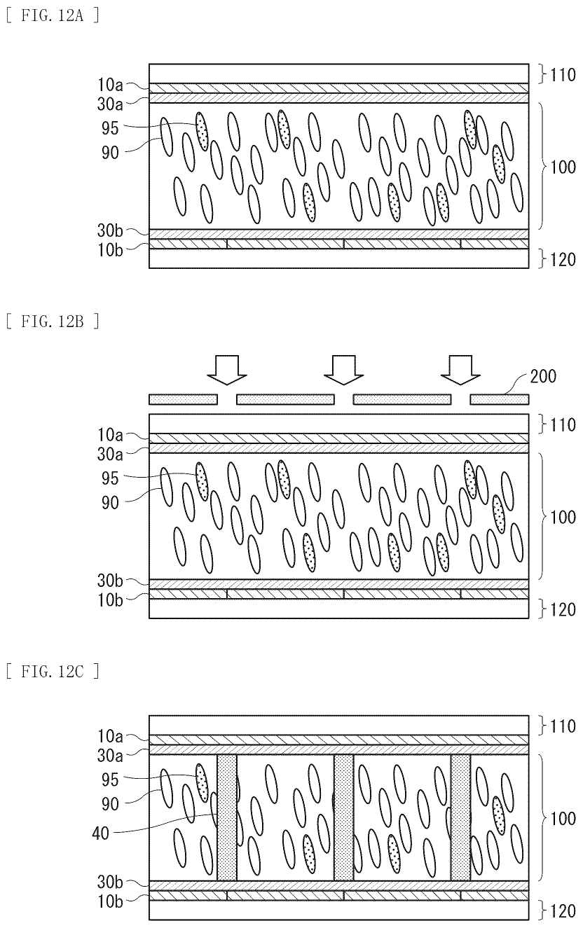

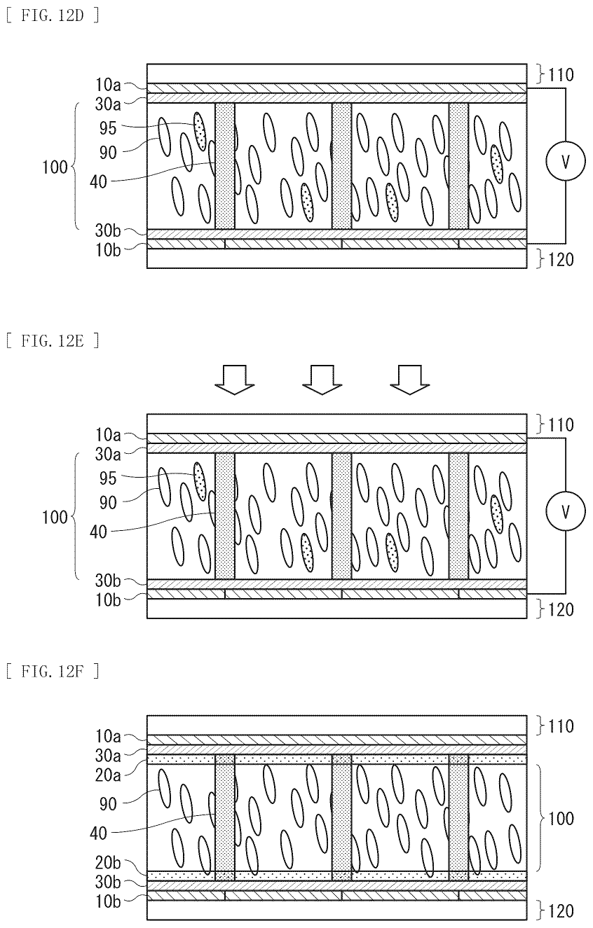

FIG. 11 is a flowchart illustrating an example of the method of manufacturing the phase modulation device according to the third embodiment. Referring to this flowchart in FIG. 11 and FIGS. 12A through 12F, the following describes an example of the method of manufacturing the phase modulation device 1. In step S31, after forming the first electrode 10a on the first substrate 110, which is a glass substrate, by sputtering and photolithography, the first substrate 110 is cleaned. Further, after forming the second electrode 10b, a transistor, and others on the second substrate 120, which is a silicon substrate, by sputtering, CVD, EB evaporation, photolithography, and other methods, the second substrate 120 is cleaned.

Oblique deposition is performed to the surface of the first substrate 110 with the deposition angle within the range of 45° to 60°, thus forming a SiO₂ film that is the first alignment film 30a. Oblique deposition is also performed to the surface of the second substrate 120 with the deposition angle within the range of 45° to 60°, thus forming a SiO₂ film that is the second alignment film 30b.

In step S32, the first substrate 110 and the second substrate 120 are made to face each other, and the first substrate 110 and the second substrate 120 are bonded together using a sealing member mixed with glass beads. In this step, the sealing member seals the liquid crystal layer 100 containing liquid crystal molecules 90 and polymerizable monomer 95 between the first substrate 110 and the second substrate 120. For instance, the liquid crystal layer 100 includes a liquid crystal composition that is prepared by mixing 4-(6-Acryloxy-hex-1-yl-oxy)phenyl 4-(hexyloxy)benzoat (manufactured by Wako Pure Chemical Corporation) and 1,4-Bis(4-(3-acryloyloxypropoxy)benzoyloxy)-2-methylbenzene (manufactured by Tokyo Kasei Kogyo) at a ratio of 1:4, and mixing 5.0 wt % of the resultant mixture with a negative-type liquid crystal material. This produces the phase modulation device 1 illustrated in FIG. 12A.

In step S33, a mask 200 is placed above the phase modulation device 1, as schematically illustrated in FIG. 12B. Then, the phase modulation device 1 is irradiated with ultraviolet light with an irradiation dose of 1000 mJ/cm² at a wavelength of 365 nm, for example, to form the structure 40. The liquid crystal layer 100 is partially irradiated with the ultraviolet light through the mask 200, whereby a part of the polymerizable monomer 95 in the liquid crystal layer 100 is polymerized, so that the structure 40 is formed as illustrated in FIG. 12C.

In step S34, as schematically illustrated in FIG. 12D, an AC electric field (e.g., a square wave AC electric field with an RMS voltage of 40 V and a frequency of 60 Hz) is applied to the phase modulation device 1 via the first electrode 10a and second electrode 10b. Note that, in some cases, a DC electric field may be applied to the phase modulation device 1. In step S35, while the AC electric field (or DC electric field) is applied to the phase modulation device 1, the phase modulation device 1 is irradiated with ultraviolet rays as schematically illustrated in FIG. 12E. In this case, the phase modulation device 1 is irradiated with ultraviolet light with an irradiation dose of 500 mJ/cm² at a wavelength of 365 nm, for example. This forms the first polymer layer 20a and the second polymer layer 20b in the phase modulation device 1, as illustrated in FIG. 12F. The entire liquid crystal layer 100 is irradiated with the ultraviolet light, whereby the remaining polymerizable monomer 95 in the liquid crystal layer 100 is polymerized. This forms the first polymer layer 20a and the second polymer layer 20b as illustrated in FIG. 12F. The manufacturing method as described above produces the phase modulation device 1 illustrated in FIG. 10.

### Workings and Effects

The phase modulation device 1 according to the present embodiment includes: a first substrate having an electrode; a second substrate opposed to the first substrate; a liquid crystal layer (liquid crystal layer 100) containing liquid crystal molecules, the liquid crystal layer being disposed between the first substrate and the second substrate; and a structure (structure 40) disposed between the first substrate and the second substrate, the structure including a polymer that is polymerized. The phase modulation device has the angle between the direction of electric field generated in the liquid crystal layer when voltage is applied to the electrode and the direction of alignment of liquid crystal molecules 90 when no voltage is applied, the angle being 2° or more and 20° or less, preferably 5° or more and 15° or less.

The phase modulation device 1 includes the structure 40 to couple the first substrate 110 and the second substrate 120. Further, the phase modulation device has the angle between the direction of electric field generated in the liquid crystal layer 100 when voltage is applied and the direction of alignment of liquid crystal molecules when no voltage is applied, the angle being 2° or more and 20° or less, preferably 5° or more and 15° or less. This makes it possible to improve the response speed of the phase modulation device 1. This makes it possible to realize the phase modulation device 1 with high response performance.

Next, the following describes modification examples of the present disclosure. In the following description, like reference numerals designate like parts of the embodiment as stated above, and their description is omitted as appropriate.

### 3-1. Modification Example 3

The above embodiment describes the example configuration of the phase modulation device 1 including the structure 40, and this is just an example. For instance, the phase modulation device 1 may not include the alignment film 30 (the first alignment film 30a and the second alignment film 30b). Furthermore, the shape and arrangement of the structure 40 are not limited to the example described above.

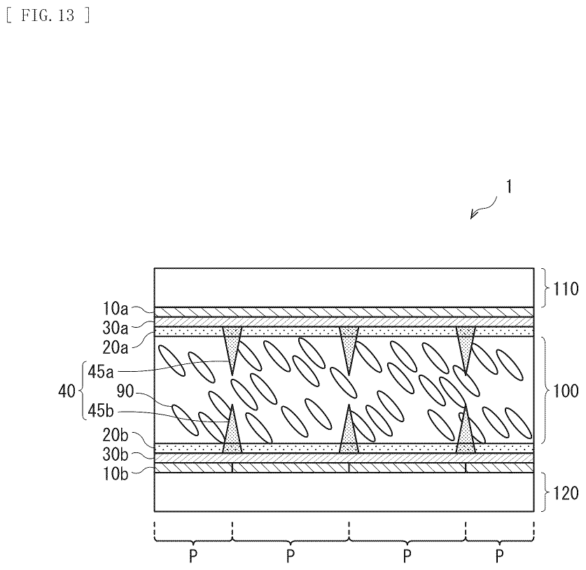

FIG. 13 illustrates an example configuration of a phase modulation device according to Modification Example 3. As illustrated in FIG. 13, the structure 40 may have a shape with a plurality of protrusions. In the example of FIG. 13, the structure 40 includes a first protrusion 45a extending from the first substrate 110 and a second protrusion 45b extending from the second substrate 120. The first protrusion 45a extends from the first substrate 110, and the second protrusion 45b extends from the second substrate 120. This modification example also leads to the same effects as those described in the above embodiment.

### 4. Fourth Embodiment

Next, the following describes a fourth embodiment of the present disclosure. In the following description, like reference numerals designate like parts of the embodiment as stated above, and their description is omitted as appropriate.

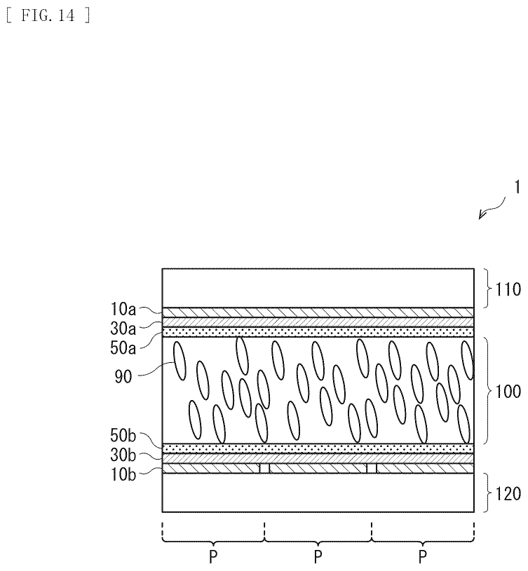

FIG. 14 illustrates an example configuration of a phase modulation device according to a fourth embodiment of the present disclosure. As illustrated in FIG. 14, the phase modulation device 1 has a protective film 50 (in FIG. 14, a first protective film 50a and a second protective film 50b). The protective film 50 is a film (layer) made of an organic material and is an organic film. For instance, the protective film 50 includes a polymer that is polymerized, and is disposed on the alignment film 30. In the example illustrated in FIG. 14, the first protective film 50a is located between the liquid crystal layer 100 and the first alignment film 30a, and is provided to cover the first alignment film 30a. The second protective film 50b is located between the liquid crystal layer 100 and the second alignment film 30b, and is provided to cover the second alignment film 30b.

The phase modulation device 1 according to the present embodiment includes the first protective film 50a and the second protective film 50b, and these protective films are able to prevent moisture from entering the first alignment film 30a and the second alignment film 30b. This suppresses moisture adsorption to the first alignment film 30a and the second alignment film 30b, and makes it possible to prevent the unevenness (variation) in the characteristics of the phase modulation device 1 and a decrease in response speed. This makes it possible to improve the water resistance (moisture resistance) of the phase modulation device 1 and improve its reliability.

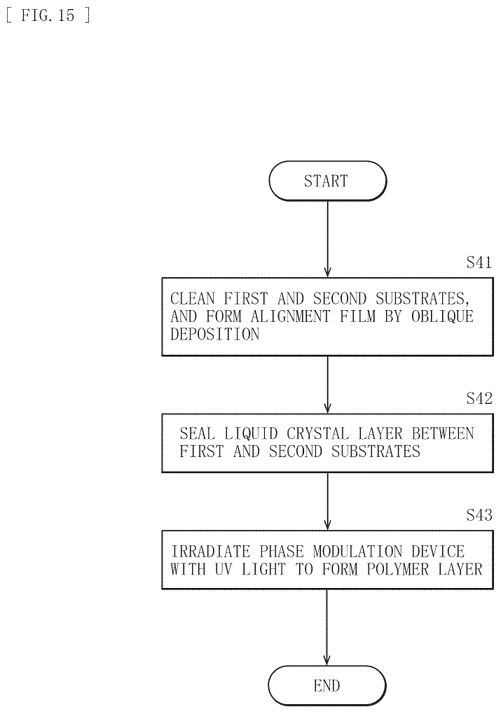

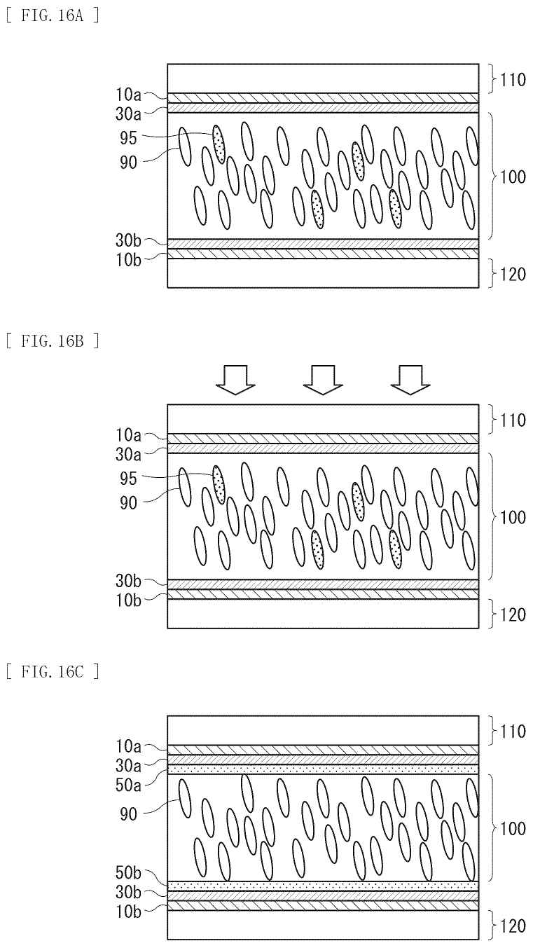

FIG. 15 is a flowchart illustrating an example of the method of manufacturing the phase modulation device according to the fourth embodiment. Referring to this flowchart in FIG. 15 and FIGS. 16A through 16C, the following describes an example of the method of manufacturing the phase modulation device 1. In step S41, after forming the first electrode 10a on the first substrate 110, which is a glass substrate, by sputtering and photolithography, the first substrate 110 is cleaned. Further, after forming the second electrode 10b, a transistor, and others on the second substrate 120, which is a silicon substrate, by sputtering, CVD, EB evaporation, photolithography, and other methods, the second substrate 120 is cleaned.

Oblique deposition is performed to the surface of the first substrate 110 with the deposition angle within the range of 45° to 60°, thus forming a SiO₂ film that is the first alignment film 30a. Oblique deposition is also performed to the surface of the second substrate 120 with the deposition angle within the range of 45° to 60°, thus forming a SiO₂ film that is the second alignment film 30b.

In step S42, the first substrate 110 and the second substrate 120 are made to face each other, and the first substrate 110 and the second substrate 120 are bonded together using a sealing member mixed with glass beads. In this step, the sealing member seals the liquid crystal layer 100 containing liquid crystal molecules 90 and polymerizable monomer 95 between the first substrate 110 and the second substrate 120. For instance, the liquid crystal layer 100 includes a liquid crystal component that is prepared by mixing 3.0 wt % of 1,4-Bis(4-(3-acryloyloxypropoxy)benzoyloxy)-2-methylbenzene (manufactured by Tokyo Kasei Kogyo) with negative liquid crystal material, for example. This produces the phase modulation device 1 illustrated in FIG. 16A.

In step S43, the phase modulation device 1 is irradiated with ultraviolet rays, as illustrated in FIG. 16B. In this case, the phase modulation device 1 is irradiated with ultraviolet light with an irradiation dose of 500 mJ/cm² at a wavelength of 365 nm, for example. This forms the first protective film 50a and the second protective film 50b in the phase modulation device 1, as illustrated in 16C. The alignment film 30 and protective film 50 give the liquid crystal molecules 90 in the liquid crystal layer 100 a pretilt angle.

The manufacturing method as described above produces the phase modulation device 1 illustrated in FIG. 14. The phase modulation device 1 according to the present embodiment is also applicable to liquid crystal display devices. The protective film 50 improves the water resistance (moisture resistance) of the liquid crystal display device, and makes it possible to suppresses display defects. Further, in the example of the manufacturing method described above, the protective film 50 is formed by irradiating with ultraviolet rays without applying a voltage. This makes it possible to maintain the pretilt angle given by the alignment film 30. This allows a small pretilt angle to be given to the liquid crystal molecules 90, thereby improving contrast. The technique of the present disclosure is applicable to a projector device where contrast is important.

Note that, in step S43 in FIG. 15 above, the phase modulation device 1 may be irradiated with ultraviolet rays while an electric field is applied thereto. This allows a large pretilt angle to be given to the liquid crystal molecules, thereby improving the response speed of the liquid crystal molecules. The technique of the present disclosure is applicable to an optical device where response speed is important. The alignment direction of liquid crystal modules may be set so that the angle between the direction of electric field generated in the liquid crystal layer 100 when voltage is applied and the direction of alignment of liquid crystal molecules when no voltage is applied is 2° or more and 20° or less, preferably 5° or more and 15° or less. This shortens the response time of the liquid crystal molecules when voltage is applied, thereby making it possible to improve the response speed.

### Workings and Effects

The phase modulation device 1 according to the present embodiment includes: a first substrate having an electrode; a second substrate opposed to the first substrate; a liquid crystal layer (liquid crystal layer 100) containing liquid crystal molecules, the liquid crystal layer being disposed between the first substrate and the second substrate; an alignment film (alignment film 30) disposed on the electrode between the first substrate and the second substrate; and a protective film (protective film 50) disposed on the alignment film.

The phase modulation device 1 includes the protective film 50 on the alignment film 30. This suppresses moisture entrance into the alignment film 30, and makes it possible to suppress a decrease in response speed of the phase modulation device 1. This also makes it possible to suppress the unevenness in the characteristics of the phase modulation device 1. Thus, this makes it possible to improve the reliability of the phase modulation device 1.

While the present disclosure has been described by way of embodiments and modification examples, the present technique is not limited to the above embodiments and other examples, and numerous modifications are possible. For instance, although the above-mentioned modification examples each have been described as a modification of the corresponding embodiment, the configurations of these modification examples may be combined as appropriate. For instance, the technique of the present disclosure is applicable also to in plane switching (IPS) and fringe field switching (FFS) type liquid crystal devices. In these cases also, the alignment direction of liquid crystal modules may be set so that the angle between the direction of electric field generated in the liquid crystal layer when voltage is applied and the direction of alignment of liquid crystal molecules when no voltage is applied is 2° or more and 20° or less, preferably 3° or more and 15° or less. This shortens the response time of the liquid crystal molecules when voltage is applied, thereby making it possible to improve the response speed.

Note that the effects described in this specification are merely examples and are not limited to the description, and other effects may also be obtainable. Further, the present disclosure may also have the following configuration.

(1)

A phase modulation device including: a first substrate having an electrode;
a second substrate opposed to the first substrate; and
a liquid crystal layer containing liquid crystal molecules, the liquid crystal layer being disposed between the first substrate and the second substrate, wherein
an angle between a direction of electric field generated in the liquid crystal layer when a voltage is applied to the electrode and a direction of alignment of the liquid crystal molecules when the voltage is not applied is 2° or more and 20° or less.
   (2)

The phase modulation device according to (1), in which the angle between the direction of the electric field generated in the liquid crystal layer when the voltage is applied to the electrode and the direction of the alignment of the liquid crystal molecules when the voltage is not applied is 5° or more and 15° or less.

(3)

The phase modulation device according to (1) or (2), further including a layer including a polymer that is polymerized, the layer being disposed on the electrode between the first substrate and the second substrate.

(4)

The phase modulation device according to any one of (1) to (3), in which the electrode has a shape having a slit or an uneven shape.

(5)

The phase modulation device according to any one of (1) to (4), further including an alignment film disposed on the electrode between the first substrate and the second substrate.

(6)

The phase modulation device according to (5), in which the alignment film is configured to control the alignment of the liquid crystal molecules.

(7)

The phase modulation device according to (5) or (6), in which the alignment film includes an inorganic material.

(8)

The phase modulation device according to any one of (5) to (7), in which the alignment film includes an obliquely deposited film.

(9)

The phase modulation device according to (5) or (6), in which the alignment film includes an organic material.

(10)

The phase modulation device according to (5) or (6), in which the alignment film includes a film whose alignment direction is defined by a rubbing process.

(11)

The phase modulation device according to any one of (5) to (10), in which the alignment film includes a photosensitive group.

(12)

The phase modulation device according to any one of (1) to (11), further including a structure disposed between the first substrate and the second substrate, the structure including a polymer that is polymerized.

(13)

The phase modulation device according to (12), in which the structure couples the first substrate and the second substrate.

(14)

The phase modulation device according to (12) or (13), in which the structure includes a first protrusion extending from the first substrate and a second protrusion extending from the second substrate.

(15)

The phase modulation device according to any one of (1) to (14), in which the liquid crystal molecules have negative dielectric anisotropy.

(16)

The phase modulation device according to any one of (1) to (15), in which the electric field generated in the liquid crystal layer is in a direction in which the first substrate and the second substrate are opposed to each other.

(17)

A phase modulation device including: a first substrate having an electrode;
a second substrate opposed to the first substrate;
a liquid crystal layer containing liquid crystal molecules, the liquid crystal layer being disposed between the first substrate and the second substrate;
an alignment film disposed on the electrode between the first substrate and the second substrate; and
a protective film disposed on the alignment film.
   (18)

The phase modulation device according to (17), in which the protective film includes a polymer that is polymerized.

(19)

A method of manufacturing a phase modulation device, the method including:
forming a liquid crystal layer including liquid crystal molecules between a first substrate having an electrode and a second substrate; and
aligning the liquid crystal molecules to cause an angle between a direction of electric field generated in the liquid crystal layer when a voltage is applied to the electrode and a direction of alignment of the liquid crystal molecules when the voltage is not applied to be 2° or more and 20° or less.
   (20)

The method of manufacturing the phase modulation device according to (19), in which the liquid crystal molecules are aligned to cause the angle between the direction of the electric field generated in the liquid crystal layer when the voltage is applied to the electrode and the direction of the alignment of the liquid crystal molecules when the voltage is not applied to be 5° or more and 15° or less.

The present application claims the benefit of Japanese Priority Patent Application JP 2022-014471 filed with the Japan Patent Office on February 1, 2022, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. A phase modulation device comprising:
a first substrate having an electrode;
a second substrate opposed to the first substrate; and
a liquid crystal layer including liquid crystal molecules, the liquid crystal layer being disposed between the first substrate and the second substrate, wherein
an angle between a direction of electric field generated in the liquid crystal layer when a voltage is applied to the electrode and a direction of alignment of the liquid crystal molecules when the voltage is not applied is 2° or more and 20° or less.

2. The phase modulation device according to claim 1, wherein the angle between the direction of the electric field generated in the liquid crystal layer when the voltage is applied to the electrode and the direction of the alignment of the liquid crystal molecules when the voltage is not applied is 5° or more and 15° or less.

3. The phase modulation device according to claim 2, further comprising a layer including a polymer that is polymerized, the layer being disposed on the electrode between the first substrate and the second substrate.

4. The phase modulation device according to claim 3, wherein the electrode has a shape having a slit or an uneven shape.

5. The phase modulation device according to claim 2, further comprising an alignment film disposed on the electrode between the first substrate and the second substrate.

6. The phase modulation device according to claim 5, wherein the alignment film is configured to control the alignment of the liquid crystal molecules.

7. The phase modulation device according to claim 5, wherein the alignment film includes an inorganic material.

8. The phase modulation device according to claim 7, wherein the alignment film includes an obliquely deposited film.

9. The phase modulation device according to claim 5, wherein the alignment film includes an organic material.

10. The phase modulation device according to claim 5, wherein the alignment film includes a film whose alignment direction is defined by a rubbing process.

11. The phase modulation device according to claim 5, wherein the alignment film includes a photosensitive group.

12. The phase modulation device according to claim 2, further comprising a structure disposed between the first substrate and the second substrate, the structure including a polymer that is polymerized.

13. The phase modulation device according to claim 12, wherein the structure couples the first substrate and the second substrate.

14. The phase modulation device according to claim 12, wherein the structure includes a first protrusion extending from the first substrate and a second protrusion extending from the second substrate.

15. The phase modulation device according to claim 2, wherein the liquid crystal molecules have negative dielectric anisotropy.

16. The phase modulation device according to claim 2, wherein the electric field generated in the liquid crystal layer is in a direction in which the first substrate and the second substrate are opposed to each other.

17. A phase modulation device comprising:
a first substrate having an electrode;
a second substrate opposed to the first substrate;
a liquid crystal layer including liquid crystal molecules, the liquid crystal layer being disposed between the first substrate and the second substrate;
an alignment film disposed on the electrode between the first substrate and the second substrate; and
a protective film disposed on the alignment film.

18. The phase modulation device according to claim 17, wherein the protective film includes a polymer that is polymerized.

19. A method of manufacturing a phase modulation device, the method comprising:
forming a liquid crystal layer including liquid crystal molecules between a first substrate having an electrode and a second substrate; and
aligning the liquid crystal molecules to cause an angle between a direction of electric field generated in the liquid crystal layer when a voltage is applied to the electrode and a direction of alignment of the liquid crystal molecules when the voltage is not applied to be 2° or more and 20° or less.

20. The method of manufacturing the phase modulation device according to claim 19, wherein the liquid crystal molecules are aligned to cause the angle between the direction of the electric field generated in the liquid crystal layer when the voltage is applied to the electrode and the direction of the alignment of the liquid crystal molecules when the voltage is not applied to be 5° or more and 15° or less.
